(19) United States
(12) Patent Application Publication
(10) Pub. No.: US 2011/0200929 A1
(43) Pub. Date: Aug. 18, 2011

(54) ELECTROSTATIC IMAGE DEVELOPING TONER AND TWO-COMPONENT DEVELOPER

(76) Inventors: Toshihiko Karato, Shizuoka (JP); Masahide Yamada, Shizuoka (JP); Junichi Awamura, Shizuoka (JP); Tomomi Suzuki, Shizuoka (JP)

(21) Appl. No.: 13/125,740

(22) PCT Filed: Oct. 23, 2009
(86) PCT No.: PCT/JP2009/068635

§ 371 Date: Apr. 22, 2011

(30) Foreign Application Priority Data
Oct. 23, 2008 (JP) 2008-273460

(51) Int. Cl. G03G 9/08; G03G 9/087

(52) U.S. Cl. 430/108.8; 430/109.3; 430/137.1

(57) ABSTRACT

The present invention provides an electrostatic image developing toner capable of improving the dispersibility of wax in the toner and superior in offset resistance and in storageability (heat-resistant storageability) at high temperatures, and a two-component developer which uses this electrostatic image developing toner. The electrostatic image developing toner includes: a binder resin, a colorant, and a release agent, wherein the binder resin contains a polyester resin, and a block copolymer which has a polyolefin backbone unit.

### TECHNICAL FIELD

The present invention relates to an electrostatic image developing toner and a two-component developer.

### BACKGROUND

In electrophotographic image forming apparatuses, contact-type heating fixation methods such as a thermal roller fixation method are widely employed. As shown in FIG. 1, a fixing device 10 used in the thermal roller fixation method includes a heating roller 11 and a pressurizing roller 12; by passing a recording sheet 21 bearing an unfixed image (unfixed toner image) 20 through a portion (nip portion) where the heating roller 11 and the pressurizing roller 12 are in contact with each other under pressure, the unfixed toner image is melted and fixed onto the recording sheet 21.

A contact-type heating fixation method typified by the thermal roller fixation method is problematic in that since the unfixed toner image on the recording sheet 21 is fixed to the recording sheet 21 by bringing the surface of a heating member (e.g. heating roller 11) into contact with the unfixed toner image, an offset phenomenon may arise in which part of the unfixed toner is attached to the heating roller 11 and when the heating roller 11 has rotated once and touches the recording sheet 21 again, the toner attached onto the recording sheet 21 transfers and smears the recording sheet 21. Further, if the toner is attached to the heating roller 11 and/or the pressurizing roller 12 too much, there is such a problem that the separability of the recording sheet 21 from the heating roller 11 and/or the pressurizing roller 12 deteriorates and the recording sheet 21 is wound around the heating roller 11 and/or the pressurizing roller 12.

To prevent the offset phenomenon and the attachment of a recording sheet to roller(s), there is a known technique in which the heating roller 11 and the pressurizing roller 12 are coated or impregnated with fixation oil, e.g. silicone oil, such that the surfaces of the heating roller 11 and the pressurizing roller 12 do not have an affinity for the toner. Meanwhile, regarding apparatuses for forming monochrome images, oilless fixing devices that are not provided with fixation oil providing mechanisms, and fixing devices that offer reduction in the amounts of fixation oil applied have been disclosed in view of miniaturization of the fixing devices and cost reduction. Further, as to such fixing devices, it is known that wax as a release agent for prevention of offset is added into toner.

Also, in order to prevent bleeding or smearing of images caused by rubbing at the time of two-sided copying and achieve high functionalization of toner such as improvement in its low-temperature fixability, there is a known technique in which besides ordinary wax for prevention of offset, a different type of wax is added. As just described, in order to improve offset resistance and other functions further, optimization of the type(s) and amount of wax in toner particles is deemed effective.

Conventionally, in an image forming apparatus which forms a full-color image using toners of several colors, a heating roller and a pressurizing roller are coated or impregnated with fixation oil, e.g. silicone oil, so as to prevent an offset phenomenon and/or secure separability of a recording sheet from the heating roller and the pressurizing roller. Also, oilless fixation of full-color toners used for such a full-color image forming apparatus is being examined. In the case of an ordinary toner for forming monochrome images, since a highly viscoelastic resin can be used as a binder resin, the intermolecular aggregation of the toner is strong when the toner melts (is fixed), and thus separability of a recording sheet from a fixing roller and offset resistance can be secured even if the wax content is low. In the case of full-color toners, however, when a highly viscoelastic binder resin is used, there is such a problem that light-transmitting properties, glossiness and/or color reproducibility cannot be sufficiently secured. Thus, in the case of full-color toners, offset resistance and separability are highly likely to be secured by the use of wax, and thus the wax content needs to be higher, which is problematic.

When the wax content is high, there is such a problem that the wax increases in particle diameter, which causes image noise. Accordingly, the dispersed particle size distribution of the wax in the toners is important as well as the wax content. There is a technique for securing offset resistance and separability by shifting the peak of the particle size distribution of wax toward relatively small particle diameters (refer to PTL 1). There is a technique for securing offset resistance and separability by shifting the peak of the particle size distribution of wax toward relatively large particle diameters (refer to PTL 2). There is disclosed a dry toner which contains a modified polyester as a toner binder, wherein the toner contains wax, and particles having wax dispersion diameters of 0.1 μm to 3 μm occupy 70% by number or more of all particles in the toner (refer to PTL 3).

Generally, wax used as a release agent is incompatible with a binder resin, so that when the wax content is increased, there is a problem of a great increase in the dispersed particle diameter of the wax in toner. Further, in the case of pulverized toner, even when the amount of wax is increased, the amount of wax released from toner particles increases in a step of pulverizing a kneaded material as a toner precursor at the time of production of the toner, so that the amount of wax actually contained in the toner particles is smaller than that of wax provided as a raw material and thus the wax cannot be effectively contained in the toner particles, which is problematic. Hence, there is such a problem that properties of the toner (offset resistance and separability between a recording sheet and fixing member(s) (a heating member and/or a pressurizing member)) cannot be sufficiently improved by the addition of the wax. In addition, there is such a problem that when the amount of released wax increases, the storageability of the toner decreases and filming arises on images.

Accordingly, for the purpose of preventing the occurrence of released wax, there has been examined a method of dispersing wax in toner particles such that the wax is relatively small in particle diameter in order to prevent the wax from shifting from inside the toner particles and being exposed at their surfaces. For instance, in view of the foregoing point, there has been proposed a toner in which the dispersibility of wax is improved by adding a polyolefin-based resin to part of a binder resin (refer to PTL 4).

As described above, the method of improving offset resistance and the separability of a recording sheet in a fixing device by the use of wax as a release agent is known. However, regarding toner for developing latent electrostatic images (which will also be referred to as “toner” for short), particularly toner for oilless fixation suitable for use in an oilless fixing device in which fixing members such as a heating member and a pressurizing member do not need fixation oil, there are such limitations as described above when the particle diameter of wax is simply adjusted. For instance, regarding the toner in which the peak of the particle size distribution of wax is shifted toward relatively small particle diameters, the amount of wax components which are medium and large in particle diameter is relatively small, so that there is such a problem that improvement in fixability and sheet separability in oilless fixation is not enough. Also regarding the toner in which the peak of the particle size distribution of wax is shifted toward relatively large particle diameters, there is a problem in keeping a balance between improvement in fixability and sheet separability and reduction of image noise in a complete oilless fixing system.

Regarding the toner in which a polyolefin-based resin is added to part of a binder resin, the part of the binder resin is modified to improve its affinity for the wax; however, if a low-polarity paraffin wax is used, the dispersibility of the wax is insufficient, and thus improvement in properties of the toner such as offset resistance, separability between a recording sheet and fixing member(s), storageability at high temperatures and filming resistance, which is attributable to the dispersibility of the wax, is not enough as in the cases of the above-mentioned toners, which is problematic.

### CITATION LIST

### Patent Literature

[PTL 1] Japanese Patent Application Laid-Open (JP-A) No. 10-161335

[PTL 2] JP-A No. 2004-126268

[PTL 3] JP-A No. 2003-131430

[PTL 4] JP-A No. 2003-330220

### SUMMARY OF INVENTION

### Technical Problem

The present invention is aimed at solving the problems in related art and achieving the following object. An object of the present invention is to provide an electrostatic image developing toner capable of improving the dispersibility of wax in the toner and superior in offset resistance and in storageability (heat-resistant storageability) at high temperatures, and a two-component developer which uses this electrostatic image developing toner.

### Solution to Problem

As a result of carrying out examinations in order to achieve the above-mentioned object, the present inventors have found that the problems can be solved by using as a binder resin a polyester resin and a block copolymer which has a polyolefin backbone unit, and the present invention has been thus completed.
<1> An electrostatic image developing toner including: a binder resin, a colorant, and a release agent, wherein the binder resin contains a polyester resin, and a block copolymer which has a polyolefin backbone unit.
<2> The electrostatic image developing toner according to <1>, wherein the amount of the block copolymer contained is 20% by mass to 120% by mass of the amount of the release agent contained.
<3> The electrostatic image developing toner according to one of <1> and <2>, wherein the block copolymer has a polyester backbone unit and a polyolefin backbone unit, and the ratio of the weight average molecular weight of the polyester backbone unit to the weight average molecular weight of the polyolefin backbone unit is in the range of 95:5 to 55:45.
<4> The electrostatic image developing toner according to any one of <1> to <3>, wherein the release agent is paraffin wax.
<5> The electrostatic image developing toner according to any one of <1> to <4>, wherein the mass average molecular weight of the polyester resin soluble in tetrahydrofuran is in the range of 1,000 to 30,000.
<6> The electrostatic image developing toner according to any one of <1> to <5>, wherein the polyester resin has an acid value of 1.0 KOHmg/g to 50.0 KOHmg/g.
<7> The electrostatic image developing toner according to any one of <1> to <6>, wherein the polyester resin has a glass transition temperature of 35° C. to 65° C.
<8> The electrostatic image developing toner according to any one of <1> to <7>, having a glass transition temperature of 40° C. to 70° C.
<9> The electrostatic image developing toner according to any one of <1> to <8>, having Dv of 3 μm to 8 μm, where Dv denotes a volume average particle diameter.
<10> The electrostatic image developing toner according to any one of <1> to <9>, wherein the ratio Dv/Dn is in the range of 1.00 to 1.25, where Dv denotes a volume average particle diameter and Dn denotes a number average particle diameter.
<11> The electrostatic image developing toner according to any one of <1> to <10>, having an average circularity of 0.92 to 1.00.
<12> The electrostatic image developing toner according to any one of <1> to <11>, produced by emulsifying or dispersing an oil phase in an aqueous medium and then removing an organic solvent, wherein the oil phase is obtained by dissolving or dispersing in the organic solvent at least the colorant, the release agent, and one or both of the binder resin containing the polyester resin and the block copolymer which has the polyolefin backbone unit, and a precursor of the binder resin.
<13> A two-component developer including: the electrostatic image developing toner according to any one of <1> to <12>, and a carrier.

### Advantageous Effects of Invention

According to the present invention, it is possible to solve the problems in related art and achieve the object of providing an electrostatic image developing toner capable of improving the dispersibility of wax in the toner and superior in offset resistance and in storageability (heat-resistant storageability) at high temperatures, and a two-component developer which uses this electrostatic image developing toner.

### BRIEF DESCRIPTION OF DRAWINGS

FIG. 1 is a schematic drawing showing how an image is fixed by a fixing device.

### DESCRIPTION OF EMBODIMENTS

The following explains suitable embodiments of the present invention.

### (Electrostatic Image Developing Toner)

An electrostatic image developing toner according to the present invention includes a binder resin, a colorant, and a release agent, wherein the binder resin contains a polyester resin, and a block copolymer which has a polyolefin backbone unit. If necessary, the electrostatic image developing toner may include other component(s).

This electrostatic image developing toner is a superior electrostatic image developing toner for oilless fixation, capable of improving the dispersibility of the release agent and achieving satisfactory performance in terms of offset resistance, separability between a recording sheet and fixing member(s) (a heating member and/or a pressurizing member) and filming resistance. It is inferred that the block copolymer which has the polyolefin backbone unit in the present invention produces such effects because the polyolefin backbone unit, which is a site having an affinity for wax in a polymer, is highly likely to come into contact with wax molecules, as opposed to the case of an ordinary random copolymer or the like.

### <Binder Resin>

The binder resin contains a polyester resin, and a block copolymer which has a polyolefin backbone unit and, if necessary, contains other binder resin(s).

### <<Polyester Resin>>

The binder resin of the electrostatic image developing toner (which will also be referred to as “toner” for short) of the present invention contains a polyester resin. As the polyester resin, it is advisable to employ a polyester resin used as a binder resin in a conventional toner, and examples thereof include a polyester resin obtained by polycondensation of a polyhydric alcohol (PO) and a polyvalent carboxylic acid (PC).

Examples of the polyhydric alcohol (PO) include dihydric alcohols (DIO) and trihydric or higher alcohols (TO), and it is preferable to use any of the dihydric alcohols (DIO) alone, or mixtures each composed of any of the dihydric alcohols (DIO) and a small amount of any of the trihydric or higher alcohols (TO). Examples of the dihydric alcohols (DIO) include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexanedimethanol, hydrogenated bisphenol A, etc.); bisphenols (bisphenol A, bisphenol F, bisphenol S, etc.); alkylene oxide (ethylene oxide, propylene oxide, butylene oxide, etc.) adducts of the alicyclic diols; and alkylene oxide (ethylene oxide, propylene oxide, butylene oxide, etc.) adducts of the bisphenols. Examples of the trihydric or higher alcohols (TO) include trihydric to octahydric or higher aliphatic alcohols (glycerin, trimethylolethane, trimethylolpropane, pentaerythritol, sorbitol, etc.); trihydric or higher phenols (trisphenol PA, phenol novolac, cresol novolac, etc.); and alkylene oxide adducts of the trihydric or higher phenols.

Examples of the polyvalent carboxylic acid (PC) include divalent carboxylic acids (DIC) and trivalent or higher carboxylic acids (TC), and it is preferable to use any of the divalent carboxylic acids (DIC) alone, or mixtures each composed of any of the divalent carboxylic acids (DIC) and a small amount of any of the trivalent or higher carboxylic acids (TC). Examples of the divalent carboxylic acids (DIC) include alkylene dicarboxylic acids (succinic acid, adipic acid, sebacic acid, etc.); alkenylene dicarboxylic acids (maleic acid, fumaric acid, etc.); and aromatic dicarboxylic acids (phthalic acid, isophthalic acid, terephthalic acid, naphthalenedicarboxylic acid, etc.). Among these, preference is given to alkenylene dicarboxylic acids having 4 to 20 carbon atoms and aromatic dicarboxylic acids having 8 to 20 carbon atoms. Examples of the trivalent or higher carboxylic acids (TC) include aromatic polyvalent carboxylic acids (trimellitic acid, pyromellitic acid, etc.) having 9 to 20 carbon atoms. Additionally, the polyvalent carboxylic acid (PC) may be selected from acid anhydrides or lower alkyl esters (methyl ester, ethyl ester, isopropyl ester, etc.) of the above-mentioned compounds and reacted with the polyhydric alcohol (PO).

As for the ratio of the polyhydric alcohol (PO) to the polyvalent carboxylic acid (PC), the equivalence ratio [OH]/[COOH] of the hydroxyl group [OH] to the carboxylic group [COOH] is generally in the range of 2/1 to 1/1, preferably in the range of 1.5/1 to 1/1, more preferably in the range of 1.3/1 to 1.02/1.

### [Weight Average Molecular Weight of Polyester Resin]

To maintain the toner's storageability at high temperatures (also referred to as “heat-resistant storageability”), effectively exhibit its low-temperature fixability and give offset resistance after modification with a prepolymer, the mass average molecular weight of the polyester resin as a component of the binder resin, that is soluble in tetrahydrofuran (THF) is preferably in the range of 1,000 to 30,000. This is because when the mass average molecular weight is less than 1,000, the heat-resistant storageability degrades owing to an increase in the amount of oligomer components, and when the mass average molecular weight is greater than 30,000, the modification with the prepolymer is insufficient owing to steric hindrance so that there is a degradation of offset resistance.

The mass average molecular weight of the polyester resin is measured by means of GPC (gel permeation chromatography), using the measuring device GPC-8220GPC (manufactured by TOSOH CORPORATION). It is advisable to carry out the measurement as follows: columns (three continuous 15-cm columns of TSK-GEL SUPER HZM-H, manufactured by TOSOH CORPORATION, are used) are stabilized in a heat chamber having a temperature of 40° C., tetrahydrofuran is poured at a flow rate of 1 ml/min as a solvent into the columns at this temperature, and 50 μl to 200 μl of a tetrahydrofuran sample solution containing a resin, whose concentration has been adjusted to between 0.05% by mass and 0.6% by mass, is injected. Regarding the measurement of the molecular weight of the sample, the molecular weight distribution of the sample is calculated from the relationship between the number of counts and the logarithmic value concerning a calibration curve produced using several kinds of standard samples of monodisperse polystyrenes. For example, standard polystyrene samples having molecular weights of 6×10², 2.1×10³, 4×10³, 1.75×10⁴, 5.1×10⁴, 1.1×10⁵, 3.9×10⁵, 8.6×10⁵, 2×10⁶ and 4.48×10⁶ respectively, produced by Pressure Chemical Co. or Toyo Soda Manufacturing Co., Ltd., are used as the standard polystyrene samples for producing the calibration curve, and a molecular weight calibration curve produced by means of at least 10 or so of the standard polystyrene samples is used so as to calculate the number average molecular weight (Mn) and the weight average molecular weight (Mw) of the toner. As for a detector, a refractive index detector is used.

### [Acid Value of Polyester Resin]

The polyester resin preferably has an acid value of 1.0 KOHmg/g to 50.0 KOHmg/g. By adjusting the acid value of the polyester resin to between 1.0 KOHmg/g and 50.0 KOHmg/g, it is possible to further enhance properties of the toner such as low-temperature fixability, high-temperature offset resistance, heat-resistant storageability, charge stability, and control of the particle diameter by the addition of a basic compound. When the acid value is greater than 50.0 KOHmg/g, the after-mentioned elongation reaction or cross-linking reaction of a modified polyester is insufficient, and thus there is an adverse effect on high-temperature offset resistance. When the acid value is less than 1.0 KOHmg/g, it is impossible to obtain dispersion stabilizing effects by a basic compound at the time of production, and the elongation reaction or cross-linking reaction of the modified polyester easily proceeds, so that there is a problem with production stability.

The acid value of the polyester resin is measured under the following conditions, in accordance with the measuring method described in JIS K0070. First, 0.5 g of polyester (the amount of components thereof soluble in ethyl acetate is 0.3 g) as a sample is added into 120 ml of toluene and dissolved therein by stirring at 23° C. for approximately 10 hours. Then 30 ml of ethanol is added to prepare a sample solution. In the case where the sample is not dissolved, solvents such as dioxane and tetrahydrofuran are used. The obtained sample for measurement is measured for its acidity at a temperature of 23° C. using a measuring system made by mounting the electrode DG113-SC (manufactured by Mettler-Toledo International Inc.) on the automatic potentiometric titrator DL-53 TITRATOR (manufactured by Mettler-Toledo International Inc.). Also, a mixed solvent of 120 ml of toluene and 30 ml of ethanol is used for correction of the system. The analysis software LABX LIGHT Version 1.0 is used for analyzing the measurement data. The acidity can be calculated using the titrator and the analysis software; specifically, it is calculated as follows: titration is carried out using a prescribed N/10 caustic potash-alcohol solution, and the acidity is calculated from the consumption of the potash-alcohol solution, utilizing Equation 1 below.

Acidity=KOH (ml)×N×56.1/Weight of sample (Equation 1)

In Equation 1, N is a factor of N/10 KOH.

### [Glass Transition Temperature of Polyester Resin]

Since the heat-resistant storageability of the polyester resin, which is a main component of the binder resin, depends upon the glass transition temperature of the polyester resin before modified, the polyester resin preferably has a glass transition temperature of 35° C. to 65° C. When the glass transition temperature of the polyester resin is lower than 35° C., the heat-resistant storageability is insufficient. When the glass transition temperature of the polyester resin is higher than 65° C., there may be an adverse effect on low-temperature fixation.

For measurement of the glass transition temperature, TG-DSC System TAS-100, manufactured by Rigaku Electric Corporation, is used. First, approximately 10 mg of a sample is placed in an aluminum container that is subsequently mounted on a holder unit and then set in an electric furnace. First, DSC measurement is carried out as follows: after heated to 150° C. from room temperature at a temperature increase rate of 10° C./min, the sample is left to stand at 150° C. for 10 minutes, then cooled to room temperature, left to stand for 10 minutes and subsequently heated to 150° C. again at a temperature increase rate of 10° C./min in a nitrogen atmosphere. The glass transition temperature (Tg) is calculated from the point of tangency between a base line and a tangent to an endothermic curve in the vicinity of the glass transition temperature, using an analyzing system in TAS-100.

### <<Block Copolymer Which Has Polyolefin Backbone Unit>>

In the present invention, the binder resin contains as its component a block copolymer which has a polyolefin backbone unit (which will also be referred to as “block copolymer” for short). The block copolymer helps the dispersion of the release agent in the toner because the polyolefin backbone unit has a strong affinity for the release agent, particularly wax. On the other hand, the block copolymer has an affinity and compatibility with the binder resin, so that it can be favorably dispersed in the toner. In particular, a block copolymer having a polyester backbone unit and a polyolefin backbone unit has an affinity for the release agent and for the polyester resin as a component of the binder resin, so that the block copolymer is suitable for use in the present invention.

The amount of the block copolymer contained in the toner is preferably 20% by mass to 120% by mass, more preferably 25% by mass to 110% by mass, of the amount of the release agent added to the toner. When the amount of the block copolymer contained is less than 20% by mass of the amount of the release agent, the release agent may not sufficiently disperse in the toner. When the amount of the block copolymer contained is greater than 120% by mass of the amount of the release agent, the amount of the release agent relative to the amount of the binder resin is inadequate, and thus the offset resistance, etc. of the toner may not be sufficiently exhibited. Regarding this electrostatic image developing toner, since the amount of the block copolymer is 20% by mass or more of the amount of the release agent, the affinity of the block copolymer for the release agent does not decrease and thus the dispersibility of the release agent improves; also, since the amount of the block copolymer is 120% by mass or less of the amount of the release agent, aggregation of the release agent, caused by too much increase in the affinity of the block copolymer for the release agent, does not arise. The amount of the block copolymer is more preferably 25% by mass to 110% by mass of the amount of the release agent.

In the case of a block copolymer which contains a polyester resin and a polyolefin-based resin as backbone resin components, the ratio of the weight average molecular weight of the polyester backbone unit to that of the polyolefin backbone unit is preferably in the range of 95:5 to 55:45, and more preferably in the range of 90:10 to 60:40. When the polyester backbone unit is greater than 95% in the ratio, the affinity of the block copolymer for the release agent weakens, and thus the dispersibility of the release agent may not be sufficiently exhibited. When the polyester backbone unit is less than 60% in the ratio, the affinity of the block copolymer for the polyester resin as a component of the binder resin weakens, and thus the compatibility of the binder resin as a whole may be insufficient. Regarding this electrostatic image developing toner, since the polyolefin backbone unit is 5% or greater in the ratio, the affinity between the block copolymer and the release agent does not decrease and a dispersing effect of the release agent can be sufficiently exhibited; also, since the polyolefin backbone unit is 45% or less in the ratio, the affinity between the block copolymer and the release agent does not become excessive and aggregation of the release agent does not arise.

Examples of an olefin able to be used to synthesize the polyolefin backbone unit as a component of the block copolymer include conventionally known ordinary olefins such as ethylene, propylene, butene and pentene. Also, as a raw material for the block copolymer, a polyolefin having a relatively low molecular weight, such as polybutene, may be used.

Examples of a polyester raw material able to be used to synthesize the polyester backbone unit as another component of the block copolymer include a polyester raw material used in producing the polyester resin as a component of the binder resin.

### —Prepolymer—

In the present invention, in view of obtaining satisfactory toner fixability at high temperatures, it is preferable to use, as a precursor of the binder resin, a prepolymer obtained by cross-linking the polyester resin and the block copolymer. The prepolymer is a polymer having a site capable of reacting with a compound having an active hydrogen group, and a reactive modified polyester resin or the like may be used as the prepolymer. Examples of the reactive modified polyester resin include isocyanate group-containing polyester prepolymers.

### ——Polyester Prepolymer——

Examples of the polyester prepolymers include a product obtained by reacting a polyisocyanate with a polyester which is a polycondensate of a polyol and a polycarboxylic acid and has an active hydrogen group.

### ——Active Hydrogen Group——

Examples of the active hydrogen group include hydroxyl groups (alcoholic hydroxyl group and phenolic hydroxyl group), amino groups, carboxyl group and mercapto group, with preference being given to alcoholic hydroxyl group.

### ——Cross-linking Agent——

An amine is used as a cross-linking agent to the reactive modified polyester resin, and a diisocyanate compound (diphenylmethane diisocyanate or the like) is used as an elongating agent. The amine functions as a cross-linking agent and/or an elongating agent to the modified polyester capable of reacting with the active hydrogen group.

As to a modified polyester such as a urea-modified polyester, obtained by reacting an isocyanate group-containing polyester prepolymer with an amine, the molecular weights of its polymeric components can be easily adjusted, so that it can be favorably used to secure properties for dry toner, particularly oilless low-temperature fixability (great separability and fixability without a release oil applying mechanism being used with a heating medium for fixation). A polyester prepolymer with a urea-modified terminal, in particular, is capable of reducing its adhesion to the heating medium for fixation while maintaining the high fluidity and transparency of an unmodified polyester resin in a temperature range for fixation.

A preferred polyester prepolymer is a polyester having at its terminal an active hydrogen group such as an acid group or hydroxyl group, into which a functional group, such as isocyanate group, that reacts with the active hydrogen group has been introduced. A modified polyester such as a urea-modified polyester is derivable from this prepolymer, and a modified polyester able to be favorably used as the binder resin is a urea-modified polyester obtained by reacting an isocyanate group-containing polyester prepolymer with an amine as a cross-linking agent and/or an elongating agent. The isocyanate group-containing polyester prepolymer can be obtained by reacting a polyisocyanate with a polyester which is a polycondensate of a polyol and a polycarboxylic acid and has an active hydrogen group. Examples of the active hydrogen group which the polyester has include hydroxyl groups (alcoholic hydroxyl group and phenolic hydroxyl group), amino groups, carboxyl group and mercapto group, with preference being given to alcoholic hydroxyl group.

### ——Polyol——

Examples of the polyol include diols and trihydric or higher polyols, and it is preferable to use any of the diols alone, or mixtures each composed of any of the diols and a small amount of any of the polyols. Examples of the diols include alkylene glycols such as ethylene glycol, 1,2-propylene glycol, 1,3-propylene glycol, 1,4-butanediol and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexanedimethanol and hydrogenated bisphenol A; bisphenols such as bisphenol A, bisphenol F and bisphenol S; alkylene oxide(ethylene oxide, propylene oxide, butylene oxide, etc.) adducts of the alicyclic diols; and alkylene oxide(ethylene oxide, propylene oxide, butylene oxide, etc.) adducts of the bisphenols. Among these, preferred compounds are alkylene glycols having 2 to 12 carbon atoms, and alkylene oxide adducts of the bisphenols, and particularly preferred compounds are alkylene oxide adducts of the bisphenols, and combinations of the alkylene oxide adducts and alkylene glycols having 2 to 12 carbon atoms. Examples of the trihydric or higher polyols include trihydric to octahydric or higher aliphatic alcohols such as glycerin, trimethylolethane, trimethylolpropane, pentaerythritol and sorbitol; trihydric or higher phenols such as trisphenol PA, phenol novolac and cresol novolac; and alkylene oxide adducts of the trihydric or higher phenols.

### ——Polycarboxylic Acid——

Examples of the polycarboxylic acid include dicarboxylic acids and trivalent or higher carboxylic acids, and it is preferable to use any of the dicarboxylic acids alone, or mixtures each composed of any of the dicarboxylic acids and a small amount of any of the trivalent or higher carboxylic acids. Examples of the dicarboxylic acids include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalenedicarboxylic acid. Among these, preference is given to alkenylene dicarboxylic acids having 4 to 20 carbon atoms and aromatic dicarboxylic acids having 8 to 20 carbon atoms. Examples of the trivalent or higher carboxylic acids include aromatic polycarboxylic acids having 9 to 20 carbon atoms, such as trimellitic acid and pyromellitic acid. Additionally, the polycarboxylic acid may be selected from acid anhydrides or lower alkyl esters (methyl ester, ethyl ester, isopropyl ester, etc.) of the above-mentioned compounds and reacted with the polyol. As for the ratio of the polyol to the polycarboxylic acid, the equivalence ratio [OH]/[COOH] of the hydroxyl group [OH] to the carboxylic group [COOH] is generally in the range of 2/1 to 1/1, preferably in the range of 1.5/1 to 1/1, more preferably in the range of 1.3/1 to 1.02/1.

### ——Polyisocyanate——

Examples of the polyisocyanate include aliphatic polyisocyanates such as tetramethylene diisocyanate, hexamethylene diisocyanate and 2,6-diisocyanatomethyl caproate; alicyclic polyisocyanates such as isophorone diisocyanate and cyclohexylmethane diisocyanate; aromatic diisocyanates such as tolylene diisocyanate and diphenylmethane diisocyanate; aromatic aliphatic diisocyanates such as α,α,α′,α′-tetramethylxylylene diisocyanate; isocyanurates; the polyisocyanates blocked with phenol derivatives, oximes, caprolactam, etc.; and combinations each composed of any two or more of these.

As for the ratio of the polyisocyanate, the equivalence ratio [NCO]/[OH] of the isocyanate group [NCO] to the hydroxyl group [OH] contained in the polyester is generally in the range of 5/1 to 1/1, preferably in the range of 4/1 to 1.2/1, more preferably in the range of 2.5/1 to 1.5/1. When [NCO]/[OH] is greater than 5, there is a degradation of low-temperature fixability. When [NCO] is less than 1 in molar ratio, the urea content of an ester decreases if a modified polyester is used, thus causing a degradation of hot offset resistance. Polyisocyanate components generally occupy 0.5% by mass to 40% by mass, preferably 1% by mass to 30% by mass, and more preferably 2% by mass to 20% by mass, of the prepolymer having an isocyanate group at its terminal. When the polyisocyanate components occupy less than 0.5% by mass, there is a degradation of hot offset resistance and a disadvantage in keeping a balance between heat-resistant storageability and low-temperature fixability. When the polyisocyanate components occupy more than 40% by mass, there is a degradation of low-temperature fixability.

The number of isocyanate groups contained in the isocyanate group-containing prepolymer per molecule is generally 1 or more, preferably 1.5 to 3 on average, and more preferably 1.8 to 2.5 on average. When the number thereof per molecule is less than 1 on average, the molecular weight of the urea-modified polyester decreases, and thus there is a degradation of hot offset resistance.

### ——Amine——

Examples of the amine include diamines, trivalent or higher amines, amino alcohols, amino mercaptans, amino acids, and compounds obtained by blocking amino groups of these compounds. Examples of the diamines include aromatic diamines such as phenylenediamine, diethyltoluenediamine and 4,4′-diaminodiphenylmethane; alicyclic diamines such as 4,4′-diamino-3,3′-dimethyldicyclohexylmethane, diaminecyclohexane and isophoronediamine; and aliphatic diamines such as ethylenediamine, tetramethylenediamine and hexamethylenediamine. Examples of the trivalent or higher amines include diethylenetriamine and triethylenetetramine. Examples of the amino alcohols include ethanolamine and hydroxyethylaniline. Examples of the amino mercaptans include aminoethyl mercaptan and aminopropyl mercaptan. Examples of the amino acids include aminopropionic acid and aminocaproic acid. Examples of the compounds obtained by blocking amino groups of these compounds include oxazolidine compounds and ketimine compounds derived from the amines and ketones (acetone, methy ethyl ketone, methyl isobutyl ketone, etc.). Among these amines, preference is given to the diamines, and mixtures each composed of any of the diamines and a small amount of any of the trivalent or higher amines.

### ——Elongation Terminator——

Further, an elongation terminator may if necessary be used to adjust the molecular weight of the polyester. Examples of the elongation terminator include monoamines such as diethylamine, dibutylamine, butylamine and laurylamine, and compounds such as ketimine compounds, produced by blocking the monoamines.

As for the ratio of the amine, the equivalence ratio [NCO]/[NHx] of the isocyanate group [NCO] contained in the isocyanate group-containing prepolymer to the amino group [NHx] contained in the amine is generally in the range of 1/2 to 2/1, preferably in the range of 1.5/1 to 1/1.5, and more preferably in the range of 1.2/1 to 1/1.2. When [NCO]/[NHx] is greater than 2 or less than 1/2, the molecular weight of the polyester decreases, and thus there is a degradation of hot offset resistance.

The weight average molecular weight of the modified polyester such as the urea-modified polyester is preferably in the range of 3,000 to 20,000. When the weight average molecular weight is less than 3,000, it is difficult to control the reaction speed, and thus a problem with production stability starts to arise. When the weight average molecular weight is greater than 20,000, the modified polyester cannot be obtained in adequate amounts, and thus an adverse effect on offset resistance starts to arise.

### <Other Binder Resin(s)>

The above-mentioned other binder resin(s) is/are not particularly limited and may be suitably selected according to the purpose.

### <Colorant>

The colorant in the present invention is not particularly limited and may be suitably selected according to the purpose, and most known dyes and pigments can be used therefor, examples of which include carbon black, nigrosine dyes, iron black, Naphthol Yellow S, Hansa Yellow (10G, 5G, G), cadmium yellow, yellow iron oxide, ocher, chrome yellow, titanium yellow, polyazo yellow, oil yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, Isoindolinone Yellow, red ochre, red lead, vermilion lead, cadmium red, cadmium mercury red, antimony vermilion, Permanent Red 4R, Para Red, Fire Red, p-chlor-o-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, oil red, quinacridone red, pyrazolone red, polyazo red, chrome vermilion, benzidine orange, perynone orange, oil orange, cobalt blue, cerulean blue, Alkali Blue Lake, Peacock Blue Lake, Victoria Blue Lake, metal-free phthalocyanine blue, phthalocyanine blue, Fast Sky Blue, Indanthrene Blue (RS, BC), indigo, ultramarine, Prussian blue, anthraquinone blue, Fast Violet B, Methyl Violet Lake, cobalt violet, manganese violet, dioxane violet, anthraquinone violet, chrome green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide, lithopone and mixtures of these colorants. The amount of the colorant contained is not particularly limited and may be suitably selected according to the purpose, and the amount is generally 1% by mass to 15% by mass, preferably 3% by mass to 10% by mass, of the amount of the toner.

The colorant may be compounded with a resin and used as a master batch. A binder resin contained in the master batch or kneaded with the master batch is not particularly limited and may be suitably selected according to the purpose. Besides the above-mentioned modified and unmodified polyester resins, examples of the binder resin include polymers of styrene or substituted styrene, such as polystyrene, poly-p-chlorostyrene and polyvinyl toluene; styrene copolymers such as styrene-p-chlorostyrene copolymer, styrene-propylene copolymer, styrene-vinyl toluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chlor-methyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer and styrene-maleic acid ester copolymer; and polymethyl methacrylate, polybutyl methacrylate, polyvinyl chloride, polyvinyl acetate, polyethylene, polypropylene, polyesters, epoxy resins, epoxy polyol resins, polyurethane, polyamides, polyvinyl butyral, polyacrylic acid resins, rosins, modified rosins, terpene resins, aliphatic or alicyclic hydrocarbon resins, aromatic petroleum resins, chlorinated paraffins and paraffin waxes. These may be used individually or in combination.

The method for producing the master batch is not particularly limited and may be suitably selected according to the purpose. For example, the master batch may be obtained by mixing and kneading a colorant and a resin for the master batch, using a shear dispersion apparatus such as a three-roll mill. At this time, in order to enhance the interaction between the colorant and the resin, an organic solvent may be used. Meanwhile, there is a so-called flushing method that is a method of mixing and kneading a colorant-containing aqueous paste with a resin and an organic solvent, transferring the colorant to the resin side and removing water and components of the organic solvent. Since this flushing method enables a wet cake of the colorant to be used without being changed in any way, it does not require a drying step and can be favorably employed in the present embodiment.

### <Release Agent>

The release agent in the present invention gives releasing effects at the interface between a fixing roller and the toner by oozing from inside the toner to the surface of the toner when the toner is heated for its fixation.

The release agent is not particularly limited may be suitably selected according to the purpose but is preferably wax, particularly paraffin wax. Paraffin wax produces superb effects in terms of offset resistance, separability between a recording sheet and fixing member(s) (a heating member and/or a pressurizing member), heat-resistant storageability and filming resistance. The release agent preferably has a relatively low melting point of 50° C. to 120° C. A wax, particularly a paraffin wax, having a relatively low melting point disperses favorably into the binder resin and thus can act effectively as a release agent at the interface between the fixing roller and the toner. This makes it possible to produce positive effects on offset resistance, without the need to apply a release material such as silicone oil to the fixing roller. The melting point of the wax is calculated by measuring the maximum endothermic peak using TG-DSC System TAS-100, a differential scanning calorimeter, manufactured by Rigaku Electric Corporation.

Specific examples of the release agent as waxes include vegetable waxes such as carnauba wax, cotton wax, tree wax and rice wax; animal waxes such as beeswax and lanolin; mineral waxes such as ozokerite and ceresin; and petroleum waxes such as paraffin wax, microcrystalline and petrolatum. Besides these natural waxes, examples thereof include synthetic hydrocarbon waxes such as Fischer-Tropsch wax and polyethylene wax; and synthetic waxes such as esters, ketones and ethers. Example thereof further include fatty acid amides such as 12-hydroxystearic acid amide, stearic acid amide, anhydrous phthalic acid imide and chlorinated hydrocarbon; and crystalline polymers each having a long alkyl group in a side chain, exemplified by homopolymers or copolymers of polyacrylates such as poly-n-stearyl methacrylate and poly-n-lauryl methacrylate, which are low-molecular-weight crystalline polymer resins (e.g. n-stearyl acrylate-ethyl methacrylate copolymer).

The amount of any of these release agents used is preferably 2% by mass to 15% by mass of the amount of the toner. When the amount is less than 2% by mass, adequate offset-preventing effects cannot be obtained. When the amount is larger than 15% by mass, there is a decrease in the transferability and durability of the toner. In view of the transferability and durability of the toner, the maximum dispersed particle diameter of the wax in the toner is preferably in the range of 0.5 μm to 2.0 μm as a major axis diameter. When the maximum dispersed particle diameter of the wax is less than 0.5 μm as a major axis diameter, the wax does not easily ooze out when the toner is fixed, and thus adequate offset-preventing effects cannot be obtained. It is advisable to measure the maximum dispersed particle diameter of the wax by pouring the toner into a solvent which dissolves the resin but does not dissolve the wax, and observing the wax with a magnification of 1,000 times by the use of an optical microscope after the resin has been dissolved.

### <Other Component(s)>

### <Charge Controlling Agent>

In the present invention, a charge controlling agent may if necessary be used for the purpose of controlling the chargeability of the electrostatic image developing toner. The charge controlling agent may be selected from known charge controlling agents, examples of which include negrosine dyes, triphenylmethane dyes, chromium-containing metal complex dyes, molybdic acid chelate pigments, rhodamine dyes, alkoxy amines, quaternary ammonium salts (including fluorine-modified quaternary ammonium salts), alkyl amides, phosphorus, phosphorus compounds, tungsten, tungsten compounds, fluorine-based activating agents, salicylic acid metal salts, and metal salts of salicylic acid derivatives. Specific examples thereof include Bontron 03 as a negrosine dye, Bontron P-51 as a quaternary ammonium salt, Bontron S-34 as a metal-containing azo dye, E-82 as an oxynaphthoic acid metal complex, E-84 as a salicylic acid metal complex, and E-89 as a phenolic condensate (which are produced by Orient Chemical Industries); TP-302 and TP-415 as quaternary ammonium salt molybdenum complexes (which are produced by Hodogaya Chemical Industries); COPY CHARGE PSY VP2038 as a quaternary ammonium salt, COPY BLUE PR as a triphenylmethane derivative, and COPY CHARGE NEG VP2036 and COPY CHARGE NX VP434 as quaternary ammonium salts (which are produced by Hoechst); LRA-901, and LR-147 as a boron complex (which are produced by Japan Carlit Co., Ltd.); copper phthalocyanine, perylene, quinacridone, azo pigments; and polymeric compounds having functional groups such as sulfonic acid group, carboxyl group and quaternary ammonium salt.

The amount of the charge controlling agent used is not particularly limited and may be suitably selected according to the purpose. The amount is determined by the type of the binder resin, the presence or absence of additive(s) used if necessary, and the toner producing method including a dispersing process, and so it is not that the amount is unequivocally limited. Nevertheless, the amount is preferably in the range of 0.1 parts by mass to 10 parts by mass, and more preferably in the range of 0.2 parts by mass to 5 parts by mass, per 100 parts by mass of the binder resin. When the amount is greater than 10 parts by mass, the chargeability of the toner is so great that the effects of the charge controlling agent are reduced, and the electrostatic suction between the toner and a developing roller increases. Consequently, there is a decrease in the fluidity of a developer and a decrease in image density.

### <<External Additive>>

External additive(s) is/are not particularly limited as long as it/they is/are to help improve fluidity, development capability and chargeability, and it/they may be suitably selected according to the purpose. For example, inorganic fine particles can be favorably used. The primary particle diameter of these inorganic fine particles is not particularly limited and may be suitably selected according to the purpose, but it is preferably 5 nm to 2 μm, and more preferably 5 nm to 500 nm. The specific surface area of the external additive(s) based upon the BET theory is preferably 20 m²/g to 500 m²/g. As for the proportion of these inorganic fine particles used, the amount of the inorganic fine particles is preferably 0.01% by mass to 5% by mass, and more preferably 0.01% by mass to 2.0% by mass, of the amount of the toner. Specific examples of the inorganic fine particles include, but are not limited to, fine particles of silica, alumina, titanium oxide, barium titanate, magnesium titanate, calcium titanate, strontium titanate, zinc oxide, tin oxide, silica sand, clay, mica, tabular spar, diatomite, chromium oxide, cerium oxide, red ochre, antimony trioxide, magnesium oxide, zirconium oxide, barium sulfate, barium carbonate, calcium carbonate, silicon carbide and silicon nitride. Among these, as a fluidizer, use of hydrophobic silica fine particles and hydrophobic titanium oxide fine particles together is preferable. Especially when hydrophobic silica fine particles and hydrophobic titanium oxide fine particles, which are both 50 μm or less in average diameter, are stirred and mixed with the toner, the electrostatic force and the van der Waals force between the particles and the toner increase greatly. Thus, the fluidizer does not detach from the toner even when they are stirred and mixed inside a developing device to obtain a desired charge level, and it is possible to obtain favorable image quality where a so-called firefly phenomenon, in which when a solid image is output and then formed, parts of the solid image are missing, or suchlike phenomenon does not arise. Furthermore, the amount of transfer residual toner can be reduced.

The titanium oxide fine particles added as the external additive are superior in environmental stability and image density stability but inferior in that charge rising properties tend to degrade. When the amount of the titanium oxide fine particles added is larger than the amount of the silica fine particles added, the above-mentioned side effects are thought to intensify. However, when the total amount of the hydrophobic silica fine particles and the hydrophobic titanium oxide fine particles added is in the range of 0.3% by mass to 1.5% by mass, charge rising properties are not much impaired, and desired charge rising properties can be obtained. It means that even when printing with the toner is repeated, stable image quality can be obtained.

### [Property of Toner]

### (Glass Transition Temperature of Toner)

The toner of the present invention preferably has a glass transition temperature of 40° C. to 70° C. When the toner has a glass transition temperature of lower than 40° C., blocking in a developing device and filming to a photoconductor easily arise. When the toner has a glass transition temperature of higher than 70° C., the low-temperature fixability easily degrades. Thus, when the glass transition temperature of the toner is in the range of 40° C. to 70° C., it is possible to obtain a toner superior in low-temperature fixability, heat-resistant storageability and durability. It is advisable to measure the glass transition temperature by a method similar to the method of measuring the glass transition temperature of the polyester resin.

### (Particle Diameter of Toner and Particle Diameter Characteristic)

The toner of the present invention preferably has a volume average particle diameter of 3.0 μm to 8.0 μm. It is generally said that the smaller the article diameter of toner is, the more advantageous it is to obtain a high-quality image with high resolution. Meanwhile, in view of transferability and cleanability, it is desirable that the particle diameter of toner be large. When the toner has a volume average particle diameter of less than 3.0 μm, the toner fuses with the surface of a carrier as a result of long-term stirring in a developing device and thus decreases the chargeability of the carrier in the case where this toner is used in a two-component developer. In the case where this toner is used as a one-component developer, filming of the toner on a developing roller, etc. and fusion of the toner with a member such as a blade for reducing the thickness of a toner layer easily arise. In the developing device, the ratio of fine powder matters a great deal; particularly when particles of the toner which are 2 μm or less in volume average particle diameter occupy more than 20% of all particles of the toner, the particles easily adhere to the carrier and, if charging is stabilized at a high level, there is trouble caused. When the toner has a volume average particle diameter of greater than 8.0 μm, it is difficult to obtain a high-quality image with high resolution and, if the toner in the developer is supplied or consumed, the toner often varies greatly in particle diameter.

The ratio (Dv/Dn) of the volume average particle diameter (Dv) to the number average particle diameter (Dn) of the toner is preferably in the range of 1.00 to 1.25. When the ratio (Dv/Dn) concerning the toner is in this range, a high-quality image with high resolution can be easily obtained. Further, when the toner is used in a two-component developer, the toner varies less in particle diameter even if the toner is supplied and consumed for a long period of time; also, favorable, stable developing properties are enabled even with a long-term stirring in the developing device. When the ratio (Dv/Dn) is greater than 1.25, the particle diameter greatly varies from toner particle to toner particle, and the behavior of the toner varies at the time of developing, etc. Thus, the reproducibility of fine dots is impaired, so that a high-quality image cannot be obtained. The ratio (Dv/Dn) is more preferably in the range of 1.00 to 1.20, and use of the toner having a ratio (Dv/Dn) in this range makes it possible to obtain an excellent image.

The average particle diameter and the particle size distribution of the toner are measured by means of the Coulter Counter method. Examples of devices for measuring the particle size distribution of toner particles include COULTER COUNTER TA-II and COULTER MULTISIZER II (both of which are manufactured by Coulter Corporation). In the present embodiment, the average particle diameter and particle size distribution of the toner are measured using the measuring device COULTER COUNTER TA-II to which the personal computer PC-9801 (manufactured by NEC Corporation) is connected via an interface for outputting the number distribution and the volume distribution (manufactured by The Institute of Japanese Union of Scientists & Engineers).

The methods for measuring the average particle diameter and particle size distribution of the toner will be explained in specific terms. Firstly, 0.1 ml to 5 ml of a surfactant (preferably alkylbenzene sulfonate) is added as a dispersant into 100 ml to 150 ml of an electrolytic solution. The electrolytic solution is an approximately 1% NaCl aqueous solution prepared using primary sodium chloride; for example, ISOTON-II (produced by Coulter Corporation) may be used. Next, 2 mg to 20 mg of a sample for measurement is added and suspended therein. The electrolytic solution in which the sample is suspended is subjected to dispersion treatment for one minute to three minutes using an ultrasonic dispersion apparatus. With respect to the dispersion solution including this sample, the volume and number of toner (particles) are measured using a measuring device with a 100 μm aperture so as to calculate the volume distribution and the number distribution.

As channels, the following 13 channels are used, and particles having diameters which are equal to or greater than 2.00 μm but less than 40.30 μm are targeted: a channel of 2.00 μm or greater but less than 2.52 μm; a channel of 2.52 μm or greater but less than 3.17 μm; a channel of 3.17 μm or greater but less than 4.00 μm; a channel of 4.00 μm or greater but less than 5.04 μm; a channel of 5.04 μm or greater but less than 6.35 μm; a channel of 6.35 μm or greater but less than 8.00 μm; a channel of 8.00 μm or greater but less than 10.08 μm; a channel of 10.08 μm or greater but less than 12.70 μm; a channel of 12.70 μm or greater but less than 16.00 μm; a channel of 16.00 μm or greater but less than 20.20 μm; a channel of 20.20 μm or greater but less than 25.40 μm; a channel of 25.40 μm or greater but less than 32.00 μm; and a channel of 32.00 μm or greater but less than 40.30 μm. The volume average particle diameter (Dv) calculated from the volume distribution obtained in this measurement, the number average particle diameter (Dn) calculated from the number distribution also obtained in this measurement, and the ratio (Dv/Dn) of the volume average particle diameter (Dv) to the number average particle diameter (Dn) are worked out.

### [Circularity of Toner]

The average circularity of the toner of the present invention is not particularly limited and may be suitably selected according to the purpose, but it is preferably in the range of 0.92 to 1.00. If the average circularity of the tone is less than 0.92, the toner has such an anomalous shape that it cannot move smoothly when transferred, and there is behavioral variation among toner particles, thereby making it impossible to obtain uniform and high transfer efficiency.

The method for measuring the circularity of the toner is not particularly limited and may be suitably selected according to the purpose; for example, it can be measured by using the flow-type particle image analyzer FPIA-2000 (manufactured by To a Medical Electronics Co., Ltd.). The following is a specific measuring method: 0.1 mL to 0.5 mL of a surfactant, preferably alkylbenzene sulfonate, is added as a dispersant into 100 mL to 150 mL of water placed in a container, from which solid impurities have previously been removed; then approximately 0.1 g to 0.5 g of a measurement sample is added. The suspension in which the sample is dispersed is subjected to dispersion treatment for about one minute to three minutes using an ultrasonic dispersion apparatus, the shape and distribution of the toner are measured by means of the analyzer, adjusting the concentration of the dispersion solution such that the number of particles of the sample is 3,000 per microliter to 10,000 per microliter, and the circularity is thus worked out.

### [Method for Producing Toner]

The method for producing the electrostatic image developing toner according to the present invention is not particularly limited and may be suitably selected according to the purpose. For example, the toner can be produced by the following method; it should, however, be noted that this production method is employed as an example of a wet production method and that the method for producing the toner of the present invention is not limited thereto and the toner can also be produced by other wet production methods or dry production methods such as a pulverization method.

First of all, a colorant, a release agent, a charge controlling agent, a polyester prepolymer, an amine, a tertiary amine compound and the like which constitute a toner composition are added into an organic solvent phase, then the mixture is dispersed or emulsified in an aqueous medium along with a polyester resin and a block copolymer having a polyolefin backbone unit, which serve as a binder resin. Thus, toner base particles are formed in the aqueous medium.

These toner base particles are formed through a process of dispersing an organic solvent phase which contains a colorant, a release agent, a charge controlling agent, a polyester prepolymer, an amine, a tertiary amine compound, etc. into the aqueous medium phase and subjecting the polymer to elongation reaction and/or cross-linking reaction in the aqueous medium so as to form a urea-modified polyester. As a method for stably forming a dispersion including a polyester prepolymer in an aqueous medium phase, there is, for example, a method of adding into an aqueous medium phase a toner raw material composition including a polyester prepolymer dissolved or dispersed in an organic solvent, and dispersing the composition with shear force. The polyester prepolymer and other components which constitute a toner composition (hereinafter also referred to as “toner raw materials”) such as the colorant, the release agent and the charge controlling agent, dissolved or dispersed in the organic solvent, may be mixed when the dispersion is formed in the aqueous medium phase; however, it is preferable, in view of the fact that the dispersed state of the toner raw materials in the produced toner improves, to mix the toner raw materials in advance, then dissolve or disperse them in the organic solvent, and subsequently add the mixture into the aqueous medium phase such that the mixture disperses. Also, the toner raw materials such as the colorant, the release agent and the charge controlling agent do not necessarily have to be already mixed when the particles are formed in the aqueous medium phase; they may be added after the particles have been formed. For example, the colorant may be added by a known dyeing method after particles which contain no colorant have been formed.

The method for dispersing the organic solvent which contains the toner raw materials is not particularly limited and may be suitably selected according to the purpose; for example, known equipment may be used therefor, such as a low-speed shear dispersion apparatus, a high-speed shear dispersion apparatus, a friction-type dispersion apparatus, a high-pressure jet dispersion apparatus or an ultrasonic dispersion apparatus. To adjust the particle diameter of the dispersion to between 2 μm and 20 μm, use of a high-speed shear dispersion apparatus is preferable. When a high-speed shear dispersion apparatus is used, its rotational speed is not particularly limited and may be suitably selected according to the purpose; for example, it is generally 1,000 rpm to 30,000 rpm, preferably 5,000 rpm to 20,000 rpm. The length of time for which the dispersing lasts is not particularly limited and may be suitably selected according to the purpose; in the case of a batch method, it is generally 0.1 minutes to 5 minutes. The temperature at the time of the dispersing is generally 0° C. to 150° C. (under pressure), preferably 40° C. to 98° C. It is desirable that the temperature be high because the dispersion including the polyester prepolymer becomes low in viscosity and thus the dispersing can be facilitated.

The amount of the aqueous medium used per 100 parts by mass of the solid content of the organic solvent phase of the polyester prepolymer is generally 50 parts by mass to 2,000 parts by mass, preferably 100 parts by mass to 1,000 parts by mass. When it is less than 50 parts by mass, the toner composition is poorly dispersed, and thus toner particles with a predetermined diameter cannot be obtained. When it is larger than 2,000 parts by mass, the amount of water treated is large, which is not economical. Additionally, a dispersant may be used if necessary. It is preferable to use a dispersant because the particle size distribution becomes sharper and the dispersion becomes more stable.

Examples of the dispersant used to emulsify and/or disperse the organic solvent phase including the polyester prepolymer and the like include anionic surfactants such as alkylbenzene sulfonates, α-olefin sulfonates and phosphoric acid esters; amine salt surfactants such as alkylamine salts, aminoalcohol fatty acid derivatives, polyamine fatty acid derivatives and imidazoline; quaternary ammonium salt cationic surfactants such as alkyltrimethyl ammonium salts, dialkyl dimethyl ammonium salts, alkyl dimethyl benzyl ammonium salts, pyridinium salts, alkyl isoquinolinium salts and benzetonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammoniumbetaine.

Use of a fluoroalkyl group-containing surfactant makes it possible to produce its effects even when used in very small amounts. Preferred examples of fluoroalkyl group-containing anionic surfactants include, but are not limited to, fluoroalkyl carboxylic acids each having 2 to 10 carbon atoms, and metal salts thereof, disodium perfluorooctanesulfonylglutamate, sodium 3-[ω-fluoroalkyl (C6 to C11) oxyl-1-alkyl (C3 or C4) sulfonate, sodium 3[ω-fluoroalkanoyl (C6 to C8)-N-ethylamino]-1-propanesulfonate, fluoroalkyl (C11 to C20) carboxylic acids and metal salts thereof, perfluoroalkylcarboxylic acids (C7 to C13) and metal salts thereof, perfluoroalkyl (C4 to C12) sulfonic acids and metal salts thereof, perfluorooctanesulfonic acid diethanolamide, N-propyl-N-(2-hydroxyethyl)perfluorooctanesulfonamide, perfluoroalkyl (C6 to C10) sulfonamide propyltrimethylammonium salts, perfluoroalkyl (C6 to C10)-N-ethylsulfonylglycine salts and monoperfluoroalkyl (C6 to C16) ethyl phosphoric acid esters. Examples thereof as products include SURFLON S-111, S-112 and S-113 (produced by Asahi Glass Co., Ltd.); FLUORAD FC-93, FC-95, FC-98 and FC-129 (produced by Sumitomo 3M Limited); UNIDYNE DS-101 and DS-102 (produced by DAIKIN INDUSTRIES, LTD.); MEGAFAC F-110, F-120, F-113, F-191, F-812 and F-833 (produced by Dainippon Ink And Chemicals, Incorporated); ECTOP EF-102, 103, 104, 105, 112, 123A, 123B, 306A, 501, 201 and 204 (produced by Tochem Products Co., Ltd.); and FTERGENT F-100 and F150 (produced by NEOS COMPANY LIMITED).

Examples of cationic surfactants include, but are not limited to, fluoroalkyl group-containing aliphatic primary amine acids, fluoroalkyl group-containing aliphatic secondary amine acids, fluoroalkyl group-containing aliphatic tertiary amine acids, aliphatic quaternary ammonium salts such as perfluoroalkyl (C6 to C10) sulfonamide propyltrimethylammonium salts, benzalkonium salts, benzetonium chloride, pyridinium salts and imidazolinium salts. Examples thereof as products include SURFLON S-121 (produced by Asahi Glass Co., Ltd.), FLUORAD FC-135 (produced by Sumitomo 3M Limited), UNIDYNE DS-202 (produced by DAIKIN INDUSTRIES, LTD.), MEGAFAC F-150 and F-824 (produced by Dainippon Ink And Chemicals, Incorporated), ECTOP EF-132 (produced by Tochem Products Co., Ltd.), and FTERGENT F-300 (produced by NEOS COMPANY LIMITED).

Also, tricalcium phosphate, calcium carbonate, titanium oxide, colloidal silica, hydroxyappetite and the like may be used as inorganic compound dispersants sparingly soluble in water.

A polymeric protective colloid may be added to stabilize dispersion droplets. Examples thereof include acids such as acrylic acid, methacrylic acid, α-cyanoacrylic acid, α-cyanomethacrylic acid, itaconic acid, crotonic acid, fumaric acid, maleic acid and maleic anhydride; hydroxyl group-containing (meth)acrylic monomers such as acrylic acid β-hydroxyethyl, methacrylic acid β-hydroxyethyl, acrylic acid β-hydroxypropyl, methacrylic acid β-hydroxypropyl, acrylic acid γ-hydroxypropyl, methacrylic acid γ-hydroxypropyl, acrylic acid-3-chloro-2-hydroxypropyl, methacrylic acid-3-chloro-2-hydroxypropyl, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide; vinyl alcohol and ethers of vinyl alcohol such as vinyl methyl ether, vinyl ethyl ether and vinyl propyl ether; esters of carboxyl group-containing compounds and vinyl alcohol, such as vinyl acetate, vinyl propionate and vinyl butyrate; acrylamide, methacrylamide, diacetone acrylamide, and methylol compounds thereof; acid chlorides such as acrylic acid chloride and methacrylic acid chloride; homopolymers and copolymers of nitrogen-containing compounds such as vinyl pyridine, vinyl pyrolidone, vinyl imidazole and ethyleneimine, and of these nitrogen-containing compounds each having a heterocyclic ring; polyoxyethylene-based compounds such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose.

The length of time for which the polyester prepolymer is subjected to the elongation reaction and/or the cross-linking reaction is selected according to the reactivity between the isocyanate group structure of the polyester prepolymer and the amine and is generally 10 minutes to 40 hours, preferably 2 hours to 24 hours. The reaction temperature is generally 0° C. to 150° C., preferably 40° C. to 98° C. Additionally, a known catalyst may be used if necessary. Specific examples thereof include dibutyltin laurate and dioctyltin laurate.

To remove the organic solvent from the obtained emulsified dispersion, a method of gradually increasing the temperate of the entire system and completely removing the organic solvent in liquid droplets by evaporation may be employed. On that occasion, spindle-shaped toner base particles can be produced by bringing about a stirred state of laminar flow in the system, strongly stirring the dispersion in a fixed temperature range, and then removing the solvent. Also, the strong stirring in the step of removing the organic solvent makes it possible to control the toner base particles so as to have a shape which is somewhere between a spherical shape and a rugby ball-like shape. Also, as to the morphology of their surfaces, it is possible to control the surfaces so as to be somewhere between smooth surfaces and ragged surfaces.

In the case where a compound soluble in acid and alkali, such as a calcium phosphate salt, is used as a dispersion stabilizer, the compound such as a calcium phosphate salt is dissolved in an acid, e.g. hydrochloric acid, then the compound such as a calcium phosphate salt is removed from the toner base particles by washing with water, for example. Besides, its removal is possible by a process such as decomposition brought about by an enzyme.

The obtained toner base particles are, if necessary, classified so as to have a desired particle size distribution. As to the classification, fine particles can be removed by means of a cyclone, a decanter, centrifugal separation, etc. in liquid. They may, of course, be classified after obtained as powder through drying; nevertheless, it is desirable in terms of efficiency that the classification be carried out in liquid. Unnecessary fine particles and coarse particles produced may be returned to a kneading step such that they can be utilized to form particles. At that time, the fine particles and the coarse particles may be in a wet state.

It is desirable that the dispersant used be removed from the obtained emulsified dispersion as much as possible. It is particularly desirable to remove the dispersant and perform the classification simultaneously.

The external additive(s) used to help improve the fluidity, development capability and chargeability of the toner is/are as described above.

The obtained toner powder that has been dried is mixed with different kinds of particles such as fine particles of the release agent, fine particles of the charge controlling agent and fine particles of the colorant, and a mechanical impact is applied to the mixed powder; by doing so, the different kinds of particles are fixed onto or fused with the toner surface. By such fixation or fusion, it is possible to prevent the different kinds of particles from detaching from the surfaces of the composite particles in which the toner serves a nucleus.

The specific means for the fixation or fusion is not particularly limited and may be suitably selected according to the purpose; for example, there is a method of applying an impact to the mixture, using a blade which rotates at high speed; and there is a method of pouring the mixture into a high-speed gas stream, accelerating the speed of the mixture, and making the particles collide with one another or making the composite particles collide with a plate. Examples of devices therefor include devices with reduced pulverization air pressure made by modifying I-TYPE MILL (manufactured by Nippon Pneumatic Mfg. Co., Ltd.) and ANGMILL (manufactured by Hosokawa Micron Group); HYBRIDIZATION SYSTEM (manufactured by NARA MACHINERY CO., LTD.); KRYPTRON SYSTEM (manufactured by Kawasaki Heavy Industries, Ltd.); and automatic mortars.

### (Two-Component Developer)

A two-component developer according to the present invention includes the above-mentioned electrostatic image developing toner of the present invention and a carrier and may, if necessary, include other component(s).

The toner of the present invention can be suitably used in a two-component developer. When used in an image forming apparatus, this two-component developer exhibits superior offset resistance and storageability (heat-resistant storageability) at high temperatures. In this case, it is advisable to mix the toner of the present invention with a magnetic carrier, and the ratio of the amount of the toner to the amount of the carrier in the developer is preferably such that the amount of the toner is in the range of 1 part by mass to 10 parts by mass per 100 parts by mass of the carrier. The magnetic carrier is not particularly limited and may be suitably selected according to the purpose; examples thereof include conventionally known magnetic carriers such as iron powder, ferrite powder, magnetite powder and magnetic resin carriers, all of which are approximately in the range of 20 μm to 200 μm in particle diameter. A coating material is not particularly limited and may be suitably selected according to the purpose; examples thereof include amino-based resins such as urea-formaldehyde resins, melamine resins, benzoguanamine resins, urea resins, polyamide resins and epoxy resins. Examples thereof also include polyvinyl-based resins and polyvinylidene-based resins such as acrylic resins, polymethyl methacrylate resins, polyacrylonitrile resins, polyvinyl acetate resins, polyvinyl alcohol resins and polyvinyl butyral resins, and polystyrene-based resins such as polystyrene resins and styrene-acrylic copolymer resins. Examples thereof further includes halogenated olefin resins such as polyvinyl chloride; polyester-based resins such as polyethylene terephthalate resins and polybutylene terephthalate resins; polycarbonate-based resins; polyethylene resins; polyvinyl fluoride resins; polyvinylidene fluoride resins; polytrifluoroethylene resins; polyhexafluoropropylene resins; copolymers of vinylidene fluoride and acrylic monomers; vinylidene fluoride-vinyl fluoride copolymers; fluoroterpolymers such as terpolymers of tetrafluoroethylene, vinylidene fluoride and non-fluorinated monomers; and silicone resins. Also, if necessary, conductive powder, etc. may be contained in these coating resins. The conductive powder is not particularly limited and may be suitably selected according to the purpose; examples thereof include metal powder, carbon black, titanium oxide, tin oxide and zinc oxide. Among these conductive powders, ones which are 1 μm or less in average particle diameter are preferable. When the average particle diameter is greater than 1 μm, it is difficult to control electrical resistance.

### EXAMPLES

Next, the present invention will be explained in more specific terms, referring to Examples and Comparative Examples. It should, however, be noted that the present invention is not confined to these Examples. The term “part(s)” mentioned below is based upon mass.

### Example 1

### <Production of Polyester (1)>

Into a reaction vessel equipped with a cooling pipe, a stirrer and a nitrogen-introducing pipe, 690 parts of bisphenol A ethylene oxide (2 mol) adduct and 335 parts of terephthalic acid were poured, and these were subjected to condensation reaction at 210° C. for 10 hours in a normal-pressure nitrogen gas stream. Thereafter the reaction was continued for 5 hours while removing water under a reduced pressure of 10 mmHg to 15 mmHg, which was followed by cooling, and a polyester (1) was thus obtained. The obtained polyester (1) had a weight average molecular weight of 6,000, an acid value of 10 KOHmg/g and a glass transition temperature of 48° C.

### <Production of Prepolymer (1)>

The following components were poured into a reaction vessel equipped with a cooling pipe, a stirrer and a nitrogen-introducing pipe, and subjected to condensation reaction at 210° C. for 8 hours in a normal-pressure nitrogen gas stream.

| | |
|---|---|
| Bisphenol A ethylene oxide (2 mol) adduct | 795 parts |
| Isophthalic acid | 200 parts |
| Terephthalic acid | 65 parts |
| Dibutyltin oxide | 2 parts |

Next, the reaction was continued for 5 hours while removing water under a reduced pressure of 10 mmHg to 15 mmHg, which was followed by such cooling that the temperature decreased to 80° C., then the components were reacted with 170 parts of isophorone diisocyanate in ethyl acetate for 2 hours, and a prepolymer (1) was thus obtained. The obtained prepolymer (1) had a weight average molecular weight of 5,000.

### <Synthesis of Block Copolymer (1)>

The following components were poured into a reaction vessel equipped with a cooling pipe, a stirrer and a nitrogen-introducing pipe, and subjected to condensation reaction at 200° C. for 10 hours in a normal-pressure nitrogen gas stream.

| | |
|---|---|
| Hydroxyl group-terminated polybutadiene (Name of | 687 parts |
| product: POLY BD R-15HT, produced by Idemitsu Kosan | |
| Co., Ltd., number average molecular weight: 1,200, hydroxyl | |
| value: 102.7 mg KOH/g) | |
| Terephthalic acid | 313 parts |

Next, the reaction was continued for 5 hours while removing water under a reduced pressure of 10 mmHg to 15 mmHg, which was followed by cooling, and a resin (1) having a polyolefin backbone (hereinafter referred to as “polyolefin backbone-containing resin (1)”) was thus obtained. The obtained polyolefin backbone-containing resin (1) had a weight average molecular weight of 3,500.

Subsequently, into a reaction vessel equipped with a cooling pipe, a stirrer and a nitrogen-introducing pipe, 670 parts of bisphenol A ethylene oxide (2 mol) adduct and 330 parts of terephthalic acid were poured, and these were subjected to condensation reaction at 210° C. for 10 hours in a normal-pressure nitrogen gas stream. Thereafter, the reaction was continued for 5 hours while removing water under a reduced pressure of 10 mmHg to 15 mmHg, which was followed by cooling, and a polyester (2) was thus obtained. The obtained polyester (2) had a weight average molecular weight of 8,040.

Into a reaction vessel equipped with a cooling pipe, a stirrer and a nitrogen-introducing pipe, 500 parts of the polyolefin backbone-containing resin (1), 500 parts of the polyester (2) and 2 parts of dibutyltin oxide were poured, and these were subjected to condensation reaction at 230° C. for 11 hours in a normal-pressure nitrogen gas stream. Thereafter, the reaction was continued for 5 hours while removing water under a reduced pressure of 10 mmHg to 15 mmHg, which was followed by cooling, and a block copolymer (1) was thus obtained. The obtained block copolymer (1) had a weight average molecular weight of 11,500.

### <Production of Toner (1)>

First, 14.3 parts of the prepolymer (1), 51 parts of the polyester (1) and 4.3 parts of the block copolymer (1) were mixed into 78.6 parts of ethyl acetate, then stirred and dissolved. Subsequently, 4.3 parts of paraffin wax as a release agent, 4 parts of copper phthalocyanine blue pigment and 2 parts of organically modified montmorillonite were added, and the mixture was stirred for 5 minutes at 60° C. and 12,000 rpm using a TK Homomixer, then dispersed for 30 minutes at 20° C. using a bead mill. The product was used as a toner material solution (1).

Next, 265 parts of tricalcium phosphate 10% suspension and 0.2 parts of sodium dodecylbenzenesulfonate were uniformly dissolved in 306 parts of ion-exchange water. Subsequently, with stirring at 12,000 rpm using a TK Homomixer, the toner material solution (1) and 2.7 parts of a ketimine compound were added, and the mixed solution was reacted with urea. While observing particle diameters and a particle diameter distribution of the mixed solution using an optical microscope, the rotational speed was increased to 14,000 rpm and the mixture was further stirred for 5 minutes, if the particle diameters were large. If the particle diameters were small, the toner material solution (1) and a ketimine compound were again added into the above-mentioned aqueous solution, the rotational speed was changed to 10,000 rpm, and the mixed solution was again reacted with urea. Subsequently, this mixed solution was stirred at 300 rpm and 30° C. for 2 hours so as to obtain anomalously shaped toner base particles. Thereafter, the solvent was removed under reduced pressure in 1.0 hour, which was followed by filtration, washing and drying, and toner base particles (1) were thus obtained.

To 100 parts of the obtained toner base particles (1), 1.0 part of hydrophobic silica as an external additive and 0.5 parts of hydrophobized titanium oxide were added, and these were mixed using HENSCHEL MIXER (manufactured by Mitsui Mining Co., Ltd.) so as to obtain a toner (1).

### Example 2

### <Production of Block Copolymer (2)>

Into a reaction vessel equipped with a cooling pipe, a stirrer and a nitrogen-introducing pipe, 622 parts of hydroxyl group-terminated polybutadiene (Name of product: POLY BD R-15HT, produced by Idemitsu Kosan Co., Ltd., number average molecular weight: 1,200, hydroxyl value: 102.7 mg KOH/g) and 378 parts of terephthalic acid were poured, and these were subjected to condensation reaction at 200° C. for 9 hours in a normal-pressure nitrogen gas stream. Thereafter, the reaction was continued for 5 hours while removing water under a reduced pressure of 10 mmHg to 15 mmHg, which was followed by cooling, and a resin (2) having a polyolefin backbone (hereinafter referred to as “polyolefin backbone-containing resin (2)”) was thus obtained. The obtained polyolefin backbone-containing resin (2) had a weight average molecular weight of 1,830.

Subsequently, into a reaction vessel equipped with a cooling pipe, a stirrer and a nitrogen-introducing pipe, 660 parts of bisphenol A ethylene oxide (2 mol) adduct and 340 parts of terephthalic acid were poured, and these were subjected to condensation reaction at 240° C. for 12 hours in a normal-pressure nitrogen gas stream. Thereafter, the reaction was continued for 7 hours while removing water under a reduced pressure of 10 mmHg to 15 mmHg, which was followed by cooling, and a polyester (3) was thus obtained. The obtained polyester (3) had a weight average molecular weight of 20,100.

Into a reaction vessel equipped with a cooling pipe, a stirrer and a nitrogen-introducing pipe, 500 parts of the polyolefin backbone-containing resin (2), 500 parts of the polyester (3) and 2 parts of dibutyltin oxide were poured, and these were subjected to condensation reaction at 230° C. for 11 hours in a normal-pressure nitrogen gas stream. Thereafter, the reaction was continued for 5 hours while removing water under a reduced pressure of 10 mmHg to 15 mmHg, which was followed by cooling, and a block copolymer (2) was thus obtained. The obtained block copolymer (2) had a weight average molecular weight of 21,800.

### <Production of Toner (2)>

A production process was carried out in the same manner as in Example 1, except that 14.3 parts of the prepolymer (1), 54 parts of the polyester (1) and 1.1 parts of the block copolymer (2) were mixed into 78.6 parts of ethyl acetate, then stirred and dissolved, and that 4.3 parts of paraffin wax as a release agent, 4 parts of copper phthalocyanine blue pigment and 2 parts of organically modified montmorillonite were subsequently added. A toner (2) was thus obtained.

### Example 3

### <Production of Toner (3)>

A production process was carried out in the same manner as in Example 1, except that 14.3 parts of the prepolymer (1), 54 parts of the polyester (1) and 1.1 parts of the block copolymer (2) were mixed into 78.6 parts of ethyl acetate, then stirred and dissolved, and that 6.0 parts of paraffin wax as a release agent, 4 parts of copper phthalocyanine blue pigment and 2 parts of organically modified montmorillonite were subsequently added. A toner (3) was thus obtained.

### Example 4

### <Production of Block Copolymer (3)>

Into a reaction vessel equipped with a cooling pipe, a stirrer and a nitrogen-introducing pipe, 687 parts of hydroxyl group-terminated polybutadiene (Name of product: POLY BD R-15HT, produced by Idemitsu Kosan Co., Ltd., number average molecular weight: 1,200, hydroxyl value: 102.7 mg KOH/g) and 313 parts of terephthalic acid were poured, and these were subjected to condensation reaction at 200° C. for 10 hours in a normal-pressure nitrogen gas stream. Thereafter the reaction was continued for 5 hours while removing water under a reduced pressure of 10 mmHg to 15 mmHg, which was followed by cooling, and a resin (3) having a polyolefin backbone (hereinafter referred to as “polyolefin backbone-containing resin (3)”) was thus obtained.

The obtained polyolefin backbone-containing resin (3) had a weight average molecular weight of 3,500. Subsequently, into a reaction vessel equipped with a cooling pipe, a stirrer and a nitrogen-introducing pipe, 677 parts of bisphenol A ethylene oxide (2 mol) adduct and 323 parts of terephthalic acid were poured, and these were subjected to condensation reaction at 210° C. for 10 hours in a normal-pressure nitrogen gas stream. Thereafter, the reaction was continued for 5 hours while removing water under a reduced pressure of 10 mmHg to 15 mmHg, which was followed by cooling, and a polyester (4) was thus obtained. The obtained polyester (4) had a weight average molecular weight of 5,140.

Into a reaction vessel equipped with a cooling pipe, a stirrer and a nitrogen-introducing pipe, 500 parts of the polyolefin backbone-containing resin (3), 500 parts of the polyester (4) and 2 parts of dibutyltin oxide were poured, and these were subjected to condensation reaction at 230° C. for 11 hours in a normal-pressure nitrogen gas stream. Thereafter, the reaction was continued for 5 hours while removing water under a reduced pressure of 10 mmHg to 15 mmHg, which was followed by cooling, and a block copolymer (3) was thus obtained. The obtained block copolymer (3) had a weight average molecular weight of 8,650.

### <Production of Toner (4)>

First, 14.3 parts of the prepolymer (1), 51 parts of the polyester (1) and 4.3 parts of the block copolymer (3) were mixed, then 4.3 parts of paraffin wax as a release agent, 4 parts of copper phthalocyanine blue pigment and 2 parts of organically modified montmorillonite were added, these materials were mixed using a mixer and then melted and kneaded using a two-roll mill, and the kneaded matter was subjected to rolling and cooling. Thereafter, the kneaded matter was pulverized and classified so as to obtain toner base particles. Subsequently, 1.0 part of hydrophobic silica as an external additive and 0.5 parts of hydrophobized titanium oxide were added per 100 parts of the obtained toner base particles, and these were mixed using HENSCHEL MIXER (manufactured by Mitsui Mining Co., Ltd.) so as to obtain a toner (4).

### Example 5

### <Production of Toner (5)>

A production process was carried out in the same manner as in Example 4, except that 14.3 parts of the prepolymer (1), 51 parts of the polyester (1) and 2.0 parts of the block copolymer (2) were mixed, and that 4.3 parts of paraffin wax as a release agent, 4 parts of copper phthalocyanine blue pigment and 2 parts of organically modified montmorillonite were subsequently added. A toner (5) was thus obtained.

### Comparative Example 1

### <Production of Toner (6)>

A production process was carried out in the same manner as in Example 1, except that 14.3 parts of the prepolymer (1) and 55 parts of the polyester (1) were mixed into 78.6 parts of ethyl acetate, then stirred and dissolved, and that 4.3 parts of paraffin wax as a release agent, 4 parts of copper phthalocyanine blue pigment and 2 parts of organically modified montmorillonite were subsequently added. A toner (6) was thus obtained.

### Comparative Example 2

### <Production of Random Copolymer (1)>

The following components were poured into a reaction vessel equipped with a cooling pipe, a stirrer and a nitrogen-introducing pipe, and subjected to condensation reaction at 230° C. for 13 hours in a normal-pressure nitrogen gas stream.

| | |
|---|---|
| Hydroxyl group-terminated polybutadiene (Name of | 310 parts |
| product: POLY BD R-15HT, produced by Idemitsu Kosan | |
| Co., Ltd., number average molecular weight: 1,200, | |
| hydroxyl value: 102.7 mg KOH/g) | |
| Terephthalic acid | 336 parts |
| Bisphenol A ethylene oxide (2 mol) adduct | 360 parts |
| Dibutyltin oxide | 2 parts |

Next, the reaction was continued for 5 hours while removing water under a reduced pressure of 10 mmHg to 15 mmHg, which was followed by cooling, and a random copolymer (1) was thus obtained. The obtained random copolymer (1) had a weight average molecular weight of 2,600.

### <Production of Toner (7)>

A production process was carried out in the same manner as in Example 1, except that 14.3 parts of the prepolymer (1), 51 parts of the polyester (1) and 4.3 parts of the random copolymer (1) were mixed into 78.6 parts of ethyl acetate, then stirred and dissolved, and that 4.3 parts of paraffin wax as a release agent, 4 parts of copper phthalocyanine blue pigment and 2 parts of organically modified montmorillonite were subsequently added. A toner (7) was thus obtained.

### Comparative Example 3

### <Production of Toner (8)>

A production process was carried out in the same manner as in Example 4, except that 14.3 parts of the prepolymer (1) and 55 parts of the polyester (1) were mixed, and that 4.3 parts of paraffin wax as a release agent, 4 parts of copper phthalocyanine blue pigment and 2 parts of organically modified montmorillonite were subsequently added. A toner (8) was thus obtained.

### (Property and Performance of Toner)

### <Weight Ratio of Block Copolymer to Wax in Toner, etc.>

Table 1 shows the ratio of the weight average molecular weight of the polyester backbone unit (polyester unit) to that of the polyolefin backbone unit (polyolefin unit) in the block copolymer contained in each of the toners (1) to (5), and also shows the weight ratio of the block copolymer to the wax in each of the toners (1) to (5). Meanwhile, toners (6) to (8) were toners, none of which contained a block copolymer.

TABLE 1

| | | | Ratio of polyester | Weight |
|---|---|---|---|---|
| | | | unit to polyolefin | ratio |
| | | | unit in weight | of block |
| | | | average molecular | copolymer |
| | | Block copolymer | weight | to wax (%) |
| Ex. 1 | Toner (1) | Block copolymer (1) | 69.7:30.3 | 100 |
| Ex. 2 | Toner (2) | Block copolymer (2) | 91.7:8.3 | 25.6 |
| Ex. 3 | Toner (3) | Block copolymer (2) | 91.7:8.3 | 18.3 |
| Ex. 4 | Toner (4) | Block copolymer (3) | 59.5:40.5 | 100 |
| Ex. 5 | Toner (5) | Block copolymer (2) | 91.7:8.3 | 46.5 |
| Comp. | Toner (6) | Not used | — | — |
| Ex. 1 | | | | |
| Comp. | Toner (7) | Not used | — | — |
| Ex. 2 | | | | |
| Comp. | Toner (8) | Not used | — | — |
| Ex. 3 | | | | |

### (Evaluation of Toner)

The offset resistance (including separability), filming resistance and heat-resistant storageability of each of the toners (1) to (5) were evaluated.

### <Evaluation of Offset Resistance>

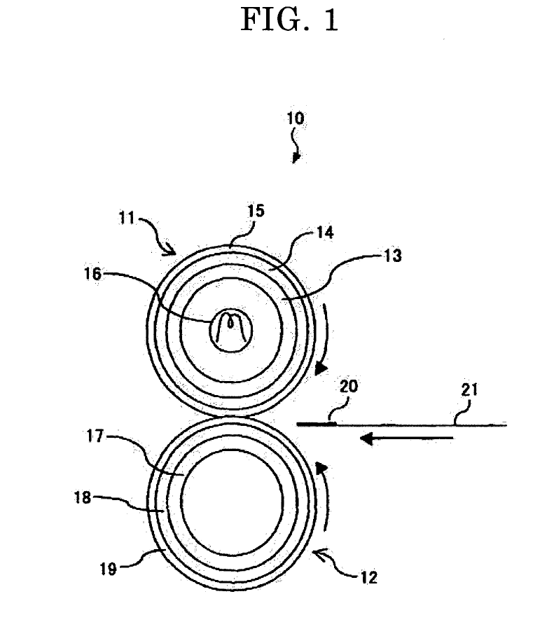

A developer was produced by mixing 7 parts of the toner subjected to an external addition process, with 93 parts of a carrier used for IPSIO COLOR 8000 (name of a copier manufactured by Ricoh Company, Ltd.). This developer was installed in IPSIO COLOR 8000, and unfixed images were produced by printing A4 short edge feed paper with belt-like solid images each having an edge length of 3 mm and a width of 36 mm (the amount of each image attached was 9 g/m²). These unfixed images were fixed using the fixing device shown in FIG. 1, in the temperature range of 130° C. to 190° C., with the temperature being changed at a rate of 10° C. By doing so, such an image-fixing temperature range as enabled the recording paper to separate smoothly from a fixing roller and did not cause offset was measured.

The fixing device had a structure in which soft rollers whose surface layers were made of fluorine-based material were used, as shown in FIG. 1, and is denoted by the numeral 10. Specifically, as shown in FIG. 1, the heating roller 11 had an outer diameter of 40 mm and included an aluminum core 13, an elastic material layer 14 which was made of silicone rubber and had a thickness of 1.5 mm and a PFA (tetrafluoroethylene-perfluoroalkyl vinyl ether copolymer) surface layer 15, with the elastic material layer 14 and the PFA surface layer 15 placed over the aluminum core 13. A heater 16 was provided inside the aluminum core. The pressurizing roller 12 had an outer diameter of 40 mm and included an aluminum core 17, an elastic material layer 18 which was made of silicone rubber and had a thickness of 1.5 mm and a PFA surface layer 19, with the elastic material layer 18 and the PFA surface layer 19 placed over the aluminum core 17. Recording paper 21 on which an unfixed image 20 (unfixed toner image) had been formed was fed in the direction of the arrow in FIG. 1. As for the recording paper used and the paper feed direction, short-grain short edge feed paper (45 g/m²) that easily became troublesome in terms of separability was used, and the circumferential speed of the fixing device was set at 120 mm/sec.

Evaluation criteria for offset resistance were as follows.

A: toner whereby, at 50° C. or higher, the recording paper was easily enabled to separate and offset was prevented

B: toner whereby, at 30° C. or higher but lower than 50° C., the recording paper was easily enabled to separate and offset was prevented

C: toner whereby, at lower than 30° C., the recording paper was easily enabled to separate and offset was prevented

### <Evaluation of Filming Resistance>

A developer was produced by mixing 7 parts of the toner subjected to an external addition process, with 93 parts of a carrier used for IPSIO COLOR 8000 (name of a copier manufactured by Ricoh Company, Ltd.). This developer was installed in IPSIO COLOR 8000, and 1,000 sheets of A4 short edge feed paper were continuously printed with letter-based image patterns each having an image area ratio of 12%. Thereafter, a further 100,000 sheets of the paper were continuously printed with the patterns. The copied images, a photoconductor and an intermediate transfer belt were visually observed before the start of use, after the 1,000 sheets had been continuously printed and after the 100,000 sheets had been continuously printed, and the filming resistance was thus evaluated.

Evaluation criteria for filming resistance were as follows.

A: the occurrence of filming was not found at all on any of the photoconductor and the intermediate transfer belt

B: the occurrence of filming was found on either the photoconductor or the intermediate transfer belt but was not found on the copied images, thus causing no problem in practical use

C: the occurrence of filming was found on the photoconductor and/or the intermediate transfer belt and was also found on the copied images, thus causing a problem in practical use

### <Evaluation of Heat-Resistant Storageability>

The toner was stored at 50° C. for 8 hours and then put through a 42 mesh sieve for 2 minutes, and the residual ratio of the toner on the mesh was used as an index of the heat-resistant storageability. The heat-resistant storageability was evaluated in the following three grades.

A: the residual ratio was less than 10%, thus causing no problem whatsoever in practical use

B: the residual ratio was 10% or greater but less than 30%, so that the toner was slightly inferior in heat-resistant storageability, but there was no problem in practical use

C: the residual ratio was 30% or greater, thus causing a problem in practical use

### <Evaluation Result>

The evaluation results of the toners (1) to (8) concerning the offset resistance, the filming resistance and the heat-resistant storageability are together shown in Table 2 along with the type of the toner produced, the volume average particle diameter (Dv), the ratio of the volume average particle diameter to the number average particle diameter (Dv/Dn), the circularity and the glass transition temperature (Tg).

TABLE 2

| | | | | | | | | | Heat- |
|---|---|---|---|---|---|---|---|---|---|
| | | | | | | | Offset | Filming | resistant |
| | | Type of | Dv | | Circu- | Tg | resis- | resis- | storage- |
| | | toner | (μm) | Dv/Dn | larity | (° C.) | tance | tance | ability |
| Ex. 1 | Toner | Polymerized | 5.2 | 1.11 | 0.969 | 51 | A | A | A |
| | (1) | toner | | | | | | | |
| Ex. 2 | Toner | Polymerized | 5.5 | 1.13 | 0.965 | 52 | A | A | A |
| | (2) | toner | | | | | | | |
| Ex. 3 | Toner | Polymerized | 5.7 | 1.15 | 0.961 | 51 | B | A | A |
| | (3) | toner | | | | | | | |
| Ex. 4 | Toner | Pulverized | 6.2 | 1.12 | 0.955 | 50 | A | A | A |
| | (4) | toner | | | | | | | |
| Ex. 5 | Toner | Pulverized | 6.1 | 1.12 | 0.95 | 50 | A | A | A |
| | (5) | toner | | | | | | | |
| Comp. | Toner | Polymerized | 7.2 | 1.22 | 0.934 | 51 | C | C | B |
| Ex. 1 | (6) | toner | | | | | | | |
| Comp. | Toner | Polymerized | 5.5 | 1.15 | 0.97 | 52 | B | C | C |
| Ex. 2 | (7) | toner | | | | | | | |
| Comp. | Toner | Pulverized | 6.5 | 1.13 | 0.955 | 50 | C | C | B |
| Ex. 3 | (8) | toner | | | | | | | |

As is evident from the evaluation results shown in Table 2, the toners of Examples 1 to 5, which are toners according to the present invention, exhibited such performance as caused no problem in practical use. All these toners except the toner of Example 3 (toner (3)) were sufficiently superior in offset resistance, separability, heat-resistant storageability and filming resistance. The toner (3) was slightly inferior in fixability and sheet separability but presented no problem in practical use. Meanwhile, the toners of Comparative Examples 1 to 3 resulted in causing a problem or problems in practical use regarding at least one of offset resistance, heat-resistant storageability and filming resistance.

### INDUSTRIAL APPLICABILITY

The electrostatic image developing toner and the two-component developer of the present invention can be widely used, for example, in laser printers, direct digital platemakers, full-color laser printers, full-color facsimiles for plain paper and full-color copiers employing direct or indirect electrophotographic multicolor image developing methods.

### REFERENCE SIGNS LIST

10 fixing device
11 heating roller
12 pressurizing roller
13 aluminum core
14 elastic material layer
15 PFA surface layer
16 heater
17 aluminum core
18 elastic material layer
19 PFA surface layer
20 unfixed image
21 recording sheet

1. An electrostatic image developing toner, comprising:
a binder resin,
a colorant, and
a release agent,
wherein the binder resin comprises a polyester resin, and a block copolymer which has a polyolefin backbone unit.

2. The toner of claim 1, wherein an amount of the block copolymer comprised is 20% by mass to 120% by mass of an amount of the release agent comprised.

3. The toner of claim 1, wherein the block copolymer has a polyester backbone unit and a polyolefin backbone unit, and a ratio of the weight average molecular weight of the polyester backbone unit to the weight average molecular weight of the polyolefin backbone unit is in a range of 95:5 to 55:45.

4. The toner of claim 1, wherein the release agent is paraffin wax.

5. The toner of claim 1, wherein a mass average molecular weight of the polyester resin soluble in tetrahydrofuran is in a range of 1,000 to 30,000.

6. The toner of claim 1, wherein the polyester resin has an acid value of 1.0 KOHmg/g to 50.0 KOHmg/g.

7. The toner of claim 1, wherein the polyester resin has a glass transition temperature of 35° C. to 65° C.

8. The toner of claim 1, having a glass transition temperature of 40° C. to 70° C.

9. The toner claim 1, having a Dv of 3 μm to 8 μm, where Dv denotes a volume average particle diameter.

10. The toner of claim 1, wherein a ratio Dv/Dn is in a range of 1.00 to 1.25, where Dv denotes a volume average particle diameter and Dn denotes a number average particle diameter.

11. The toner of claim 1, having an average circularity of 0.92 to 1.00.

12. The toner of claim 1, produced by
emulsifying or dispersing an oil phase in an aqueous medium, and then
removing an organic solvent,
wherein the oil phase is obtained by dissolving or dispersing in the organic solvent at least the colorant, the release agent, and one or both of the binder resin comprising the polyester resin and the block copolymer which has the polyolefin backbone unit, and a precursor of the binder resin.

13. A two-component developer comprising:
an electrostatic image developing toner comprising a binder resin, a colorant, and a release agent; and
a carrier
wherein the binder resin comprises a polyester resin, and a block copolymer which has a polyolefin backbone.

14. The toner of claim 2, wherein the block copolymer has a polyester backbone unit and a polyolefin backbone unit, and a ratio of the weight average molecular weight of the polyester backbone unit to the weight average molecular weight of the polyolefin backbone unit is in a range of 95:5 to 55:45.

15. The toner of claim 2, wherein the release agent is paraffin wax.

16. The toner of claim 3, wherein the release agent is paraffin wax.

17. The toner of claim 2, wherein a mass average molecular weight of the polyester resin soluble in tetrahydrofuran is in a range of 1,000 to 30,000.

18. The toner of claim 3, wherein a mass average molecular weight of the polyester resin soluble in tetrahydrofuran is in a range of 1,000 to 30,000.

19. The toner of claim 4, wherein a mass average molecular weight of the polyester resin soluble in tetrahydrofuran is in a range of 1,000 to 30,000.

20. The toner of claim 2, wherein the polyester resin has an acid value of 1.0 KOHmg/g to 50.0 KOHmg/g.
